(19) United States
(12) Patent Application Publication
(10) Pub. No.: US 2015/0379957 A1
(43) Pub. Date: Dec. 31, 2015

(54) MOBILE TILE RENDERER FOR VECTOR DATA

(71) Applicants: Ulrich Roegelein, Gaiberg (DE); Uwe Reimitz, Wiesloch (DE); Juergen Gatter, Rauenberg (DE); Wolfgang G. Mueller, Wiesloch (DE); Martina Gozlinski, Frankenthal (DE); Dimitar Vangelovski, Heidelberg (DE); Siegfried Peisl, Ketsch (DE); Markus Kupke, Dielheim (DE); Ralf M. Rath, Mannheim (DE)

(72) Inventors: Ulrich Roegelein, Gaiberg (DE); Uwe Reimitz, Wiesloch (DE); Juergen Gatter, Rauenberg (DE); Wolfgang G. Mueller, Wiesloch (DE); Martina Gozlinski, Frankenthal (DE); Dimitar Vangelovski, Heidelberg (DE); Siegfried Peisl, Ketsch (DE); Markus Kupke, Dielheim (DE); Ralf M. Rath, Mannheim (DE)

(21) Appl. No.: 14/319,083

(22) Filed: Jun. 30, 2014

(51) Int. Cl. G09G 5/00; G06T 1/60; G06T 3/40; G06T 1/20

(52) U.S. Cl. CPC G09G 5/005; G06T 1/20; G06T 1/60; G06T 3/4092; G09G 2340/145; G09G 2340/045; G09G 2340/0407; G06T 2200/16; G06T 2210/36; G06T 2210/32

(57) ABSTRACT

The present disclosure describes methods, systems, and computer program products for providing access to vector data on a mobile device providing. A corresponding may comprise a mobile device; a server remote from the mobile device; the mobile device configured to: transmit, from the mobile device to the remote server, one or more requests for first vector data, the requests specifying the first vector data, a display property of the mobile device, a first zoom level and a location within the vector data; and the remote server configured to: determine, based on the one or more requests, one or more image tiles representing information of the requested first vector data; and provide the one or more image tiles to the mobile device for display.

### TECHNICAL FIELD

The present disclosure relates to software, computer systems, and computer-implemented methods for providing access to vector data on a mobile device. Specifically, a user of a mobile device is provided with access to vector data (e.g., Computer-Aided Design (CAD) data) and can read and/or edit the vector data using the mobile device.

### BACKGROUND

Vector data can be used for a variety of purposes in computing, navigation, construction work, logistics, research, and development. Vector data allows the use of computer systems to assist in the creation, modification, analysis, or optimization of a design of a physical object. Associated software may be used to increase the productivity of the designer, improve the quality of design, improve communications through documentation, and to create a database for manufacturing. Vector data is often in the form of electronic files for print, machining, or other manufacturing operations.

One example of vector data is Computer-Aided Design (CAD) data, which is used in many fields. The use of CAD in designing electronic systems is known as Electronic Design Automation (EDA). In mechanical design the use of CAD is known as Mechanical Design Automation (MDA) or computer-aided drafting, which includes the process of creating a technical drawing with the use of computer software.

CAD software for mechanical design uses vector-based graphics to depict the objects of traditional drafting. As in the manual drafting of technical and engineering drawings, the output of CAD may convey a variety of information, such as materials, processes, dimensions, and tolerances, according to application-specific purposes.

CAD may be used to design curves and figures in two-dimensional (2D) space; or curves, surfaces, and solids in three-dimensional (3D) space. CAD is thus an important industrial art extensively used in many applications, including automotive, shipbuilding, and aerospace industries, industrial and architectural design, prosthetics, and many more. CAD is also widely used to produce computer animation for special effects in movies, advertising and technical manuals, often called Digital content creation (DCC). Because of its enormous economic importance, CAD has been a major driving force for research and development in computational geometry, computer graphics (both hardware and software), discrete differential geometry, and computer-aided research and development.

However, due to the complexity and large size of vector data, it is an obstacle to provide access to vector data on mobile devices. Thus there exists a need for viewing and/or editing of vector data on mobile devices.

### SUMMARY

The present disclosure relates to software, computer systems, and computer-implemented methods for providing access to vector data on a mobile device. Specifically, a user of a mobile device is provided with access to Computer-Aided Design (CAD) data and can read or edit the CAD data using the mobile device.

One or more of the following aspects of this disclosure can be embodied alone or in combination as methods that include the corresponding operations. One or more of the following aspects of this disclosure can be implemented alone or in combination in a device comprising a processor, a processor-readable medium coupled to the processor having instructions stored thereon which, when executed by the processor, cause the processor to perform operations according to the one or more of the following aspects. One or more of the following aspects of this disclosure can be implemented alone or in combination on a computer program product encoded on tangible storage medium, the product comprising computer readable instructions for causing one or more computers to perform the operations according to the one or more of the following aspects.

In a general aspect 1, a computer-implemented method for providing access to vector data on a mobile device, the method comprising: receiving, at a remote server and from the mobile device, one or more requests for first vector data, the requests specifying the first vector data, a display property of the mobile device, a first zoom level and a location within the vector data; determining, by the remote server and based on the one or more requests, one or more image tiles representing information of the requested first vector data; and providing, by the remote server, the one or more image tiles to the mobile device for display.

In a general aspect 2, a computer-implemented method for receiving access to vector data on a mobile device, the method comprising: transmitting, from the mobile device to a remote server, one or more requests for first vector data, the requests specifying the first vector data, a display property of the mobile device, a first zoom level and a location within the vector data; and receiving, by the mobile device, one or more image tiles representing information of the requested first vector data.

In a general aspect 3, a system for providing access to vector data on a mobile device, the system comprising: a mobile device; a server remote from the mobile device; the mobile device configured to: transmit, from the mobile device to the remote server, one or more requests for first vector data, the requests specifying the first vector data, a display property of the mobile device, a first zoom level and a location within the vector data; and the remote server configured to: determine, based on the one or more requests, one or more image tiles representing information of the requested first vector data; and provide the one or more image tiles to the mobile device.

Aspect 4 according to any one of aspects 1 to 3, wherein the vector data is Computer-Aided Design (CAD) data and/or text data.

Aspect 5 according to any one of aspects 1 to 4, wherein the determining, by the remote server, of the one or more image tiles includes: identifying, by the remote server, the one or more image tiles in a tile cache and retrieving, by the server, the one or more image tiles from the tile cache.

Aspect 6 according to aspect 5, wherein the location includes two-dimensional tile coordinates, and wherein the identifying of the one or more image tiles in the cache includes identifying a quad key associated with the one or more image tiles.

Aspect 7 according to any one of aspects 1 to 6, wherein the determining, by the remote server, of the one or more image tiles includes: rendering, by the remote server, the requested vector data; generating, by the remote server, the one or more image tiles from the rendered vector data according to the display property, the zoom level and the location; and storing, by the remote server, the generated one or more image tiles in a cache.

Aspect 8 according to any one of aspects 1 to 7, wherein the location includes two-dimensional tile coordinates, and wherein the generating, by the remote server, of the one or more image tiles from the rendered vector data includes: combining the coordinates into a one-dimensional string, which identifies the image tiles at the zoom level.

Aspect 9 according to any one of aspects 1 to 8, further comprising: before the receiving of the one or more requests, performing, by the mobile device, a pre-processing, the pre-processing comprising: constructing one or more additional requests for additional vector data associated with the requested vector data, the additional requests specifying the additional vector data; determining, by the remote server and based on the one or more additional requests, one or more additional image tiles representing information of the requested additional vector data; and providing, by the remote server, the one or more additional image tiles to the mobile device for display.

Aspect 10 according to aspect 9, wherein the additional requests specify one or more other zoom levels, and wherein the additional vector data is data associated with the other zoom levels, or wherein the additional requests specify one or more other locations, and wherein the additional vector data is data associated with the other locations.

Aspect 11 according to any one of aspects 1 to 10, further comprising: receiving, by the server and from the mobile device, a query for data associated with an object within the image tiles; retrieving the data associated with the object from metadata associated with the first vector data; and providing, by the remote server, the retrieved data associated with the object to the mobile device for display.

Aspect 12 according to any one of aspects 1 to 11, further comprising: before the transmitting of the one or more requests, performing, by the mobile device, a pre-processing, the pre-processing comprising: determining a required number of the image tiles associated with the requested vector data based on the zoom level and a size of the display of the mobile device; and transmitting, before the receiving of the one or more image tiles, the determined number of the image tiles to the remote server, wherein the number of the received one or more image tiles is substantially equal to the required number of the image tiles.

Aspect 13 according to any one of aspects 1 to 12, further comprising: transmitting, from the mobile device to a remote server, a command to modify the first vector data; and receiving, by the mobile device, one or more updated image tiles representing information of modified first vector data that was modified by the server according to the command.

Aspect 14 according to any one of aspects 1 to 13, further comprising: displaying, by the mobile device, the one or more image tiles; receiving a user navigation with respect to the displayed image tiles; and pre-fetching additional information along a dimension of the user navigation, wherein more information is pre-fetched for the dimension in which the user navigation is the fastest, preferably wherein the dimension includes at least one of zoom level, X coordinate of the display area, or Y coordinate of the display area.

Aspect 15 according to any one of aspects 1 to 14, wherein the pre-fetching of the additional information comprises: downloading, by the mobile device and during the receiving of the user navigation, image tiles outside a periphery of the currently displayed image tiles for subsequent display.

Aspect 16 according to any one of aspects 1 to 15, further comprising: displaying, by the mobile device, the one or more image tiles; and requesting, by the mobile device and from the server, neighboring image tiles that are neighboring to the currently displayed image tiles, wherein the neighboring image tiles are pre-fetched.

Aspect 17 according to any one of aspects 1 to 16, further comprising: receiving, at the mobile device, one or more requests for second vector data different from the first vector data, the second requests specifying the second vector data; determining, by the mobile device, that the requests for the first vector data are likely of lower priority than the requests for the second vector data; initiating, by the mobile device, the remote server to prioritize the requests for the second vector data over the requests for the first vector data; transmitting, by the mobile device, the requests for the second vector data to the remote server; and receiving, by the mobile device and from the remote server, one or more image tiles representing information of the requested second vector data before the one or more image tiles representing information of the requested first vector data.

Aspect 18 according to any one of aspects 1 to 17, wherein the remote server is communicatively connected to a tile cache, wherein the remote server is further configured to: render the requested vector data; generate the one or more image tiles from the rendered vector data according to the display property, the zoom level and the location; and store the generated one or more image tiles in the tile cache, wherein the stored image tiles are configured to be retrieved by the server for subsequent requests for a portion of the first vector data.

The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example of a network environment which may be used for the present disclosure.

FIG. 2 illustrates examples for rendering vector data, such as Computer-aided design (CAD) data.

FIG. 3 illustrates tile-based rendering.

FIG. 4 illustrates an example process for providing access to vector data on a mobile device.

FIG. 5 illustrates an exemplary process for receiving access to vector data on the mobile device.

FIG. 6A illustrates an example graphical user interface (GUI) for viewing vector data on a mobile device.

FIGS. 6B-C illustrate an example graphical user interface for initiating a modification of vector data by using image tiles on the mobile device.

FIG. 7 illustrates an exemplary method or process for providing interactive access to vector data on a mobile device.

### DETAILED DESCRIPTION

The present disclosure relates to software, computer systems, and computer-implemented methods for providing access to vector data on a mobile device. In some instances, a user of a mobile device is provided with access to Computer-Aided Design (CAD) data and can read or edit the CAD data using the mobile device.

First, a user of a mobile device can read and modify vector data in an efficient manner by using image tiles displayed on the mobile device. For example, the user may directly access an interactive object displayed in association with the image tiles to modify the vector data associated with the image tiles. The large amount of vector data is located on the server-side, while the mobile device only needs to handle the much smaller sizes of image tiles. As the vector data is not transmitted to the clients and stays on the server, copyrights may not be infringed.

Second, the mobile device may perform a pre-processing to increase speed of subsequent (i) navigation across the vector data, or (ii) modification of the vector data.

Third, the user may query information related to the displayed image tiles and may be provided with the information.

Fourth, local construction work, logistic operations or machine development may be performed in a more efficient manner, e.g., by benefiting from mobile and rapid prototyping of physical objects. Additionally, most providers of vector data don't like to distribute their vector data directly, providing it in images helps them to keep their intellectual property.

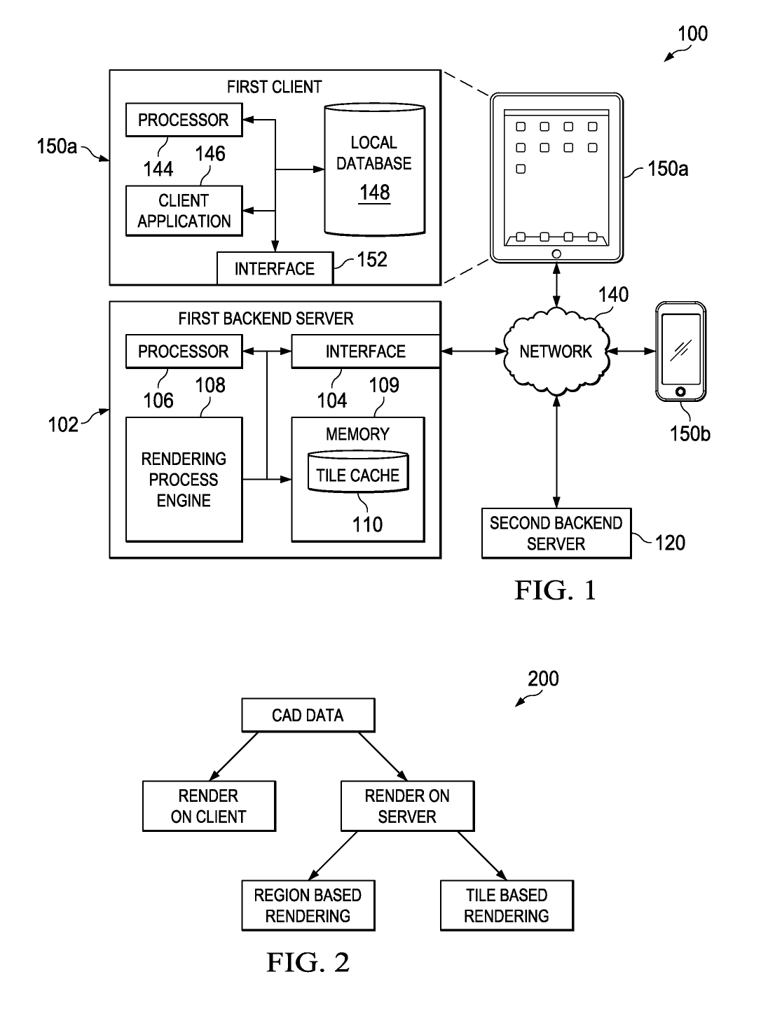

FIG. 1 illustrates an example network environment or system 100 for implementing various features of a system for providing access to vector data on a mobile device. The illustrated environment 100 includes, or is communicably coupled with, (e.g., front-end) clients or mobile devices 150a, 150b, which represents a customer installation (e.g., an on-demand or an on-premise installation) or a user in a cloud-computing environment, and backend or remote server systems 102, 120. In some instances, the front-end client or mobile device 150a, 150b may co-reside on a single server or system, as appropriate. At least some of the communications between the client 150a and 150b and the backend servers 102, 120 may be performed across or via network 140 (e.g., via a LAN or wide area network (WAN) such as the Internet). In an aspect, environment 100 depicts an example configuration of a system for establishing business networks using networked applications built on a shared platform in a cloud computing environment, such as environment 100. The client 150a, 150b and/or the server 102, 120 may include development technology and hosted and managed services and applications built on top of the underlying platform technology. In an implementation of the present disclosure described herein, the term “platform technology” is understood as types of Java development platform, such as e.g., Enterprise JavaBeans® (EJB), J2EE Connector Architecture (JCA), Java Messaging Service (JMS), Java Naming and Directory Interface (JNDI), and Java Database Connectivity (JDBC). In an implementation of the present disclosure described herein, the term “platform technology” comprises an SAP ByDesign platform, SuccessFactors Platform, SAP NetWeaver Application Server Java, ERP Suite technology or in-memory database such as High Performance Analytic Appliance (HANA) platform.

The illustrated environment 100 of FIG. 1 includes one or more (e.g., front-end) clients 150a, 150b. The client 150a, 150b may be associated with a particular network application or development context, as well as a particular platform-based application system. The clients 150a, 150b may be any computing device operable to connect to or communicate with at least one of the servers 102, 120 using a wireline or wireless connection via the network 140, or another suitable communication means or channel. In some instances, the client 150a may be a part of or associated with a business process involving one or more network applications, or alternatively, a remote developer associated with the platform or a related platform-based application.

In general, the client 150a, 150b includes a processor 144, an interface 152, a client application 146 or application interface, a graphical user interface (GUI), and a memory or local database 148. In general, the client 150a, 150b includes electronic computer devices operable to receive, transmit, process, and store any appropriate data associated with the environment 100 of FIG. 1. As used in this disclosure, the client or mobile device 150a, 150b is intended to encompass a personal computer, laptop, tablet PC, workstation, network computer, kiosk, wireless data port, smart phone, mobile phone, personal data assistant (PDA), one or more processors within these or other devices, or any other suitable processing device. The client 150a, 150b may be a mobile communication device. For example, the client 150a, 150b may comprise a computer that includes an input device, such as a keypad, touch screen, mouse, or other device that can accept user information, and an output device that conveys information associated with the operation of one or more client applications, on-demand platforms, and/or the client 150a, 150b itself, including digital data, visual information, or GUI.

Both the input and output device may include fixed or removable storage media such as a magnetic storage media, CD-ROM, or other suitable media, to both receive input from and provide output to users of client 150a, 150b through the display, namely, the GUI. The client application 146 or application interface can enable the client 150a, 150b to access and interact with applications and modules in backend server systems using a common or similar platform. The client application may be a renderer application for image tiles (e.g., a software program, allowing the user to view and/or edit the image tiles). The client application 146 allows the client 150a, 150b to request and view content on the client 150a, 150b. In some implementations, the client application 150a, 150b can be and/or include a web browser. In some implementations, the client application 146 can use parameters, metadata, and other information received at launch to access a particular set of data from the server 102, 120. Once a particular client application 146 is launched, the client can process a task, event, or other information which may be associated with the server 102, 120. Further, although illustrated as a single client application 146, the client application 146 may be implemented as multiple client applications in the client 150a, 150b.

There may be any number of clients 150a, 150b associated with, or external to, environment 100. For example, while illustrated environment 100 includes one client 150a, 150b, alternative implementations of environment 100 may include multiple clients communicably coupled to the one or more of the systems illustrated. In some instances, one or more clients 150a, 150b may be associated with administrators of the environment, and may be capable of accessing and interacting with the settings and operations of one or more network applications, and/or other components of the illustrated environment 100. Additionally, there may also be one or more additional clients 150a, 150b external to the illustrated portion of environment 100 capable of interacting with the environment 100 via the network 140. Further, the terms “client,” “customer,” and “user” may be used interchangeably as appropriate without departing from the scope of this disclosure. Moreover, while the client 150a, 150b is described in terms of being used by a single user, this disclosure contemplates that many users may use one computer, or that one user may use multiple computers. In general, clients may usually belong to one customer or company. Several employees of the customer, called users, can use the applications deployed on the corresponding client. For instance, the term “client” refers to a system providing a set of client applications belonging to or rented by a particular customer or business entity. Several employees of that particular customer or business entity can be users of that client and use the network applications provided by or available on this client.

The data stored in the local database 148 may be locked and accessed by the first backend server 102, and interacted with the front-end client 150a, 150b. In other instances, the data may be used by a Rendering Process Engine 108 associated with one of the other backend servers 120 for processing applications associated with those systems. For example, one or more of the components illustrated within the backend servers 102, 120 may be located in multiple or different servers, cloud-based or cloud computing networks, or other locations accessible to the backend servers 102, 120 (e.g., either directly or indirectly via network 140). For example, each backend server 102, 120 and/or client 150a, 150b may be a Java 2 Platform, Enterprise Edition (J2EE)-compliant application server that includes technologies such as Enterprise JavaBeans® (EJB), J2EE Connector Architecture (JCA), Java Messaging Service (JMS), Java Naming and Directory Interface (JNDI), and Java Database Connectivity (JDBC). In some instances, each of the backend servers 102, 120 may store a plurality of various applications, while in other instances, the backend servers 102, 120 may be dedicated servers meant to store and execute certain network applications built based on the on-demand platform using the on-demand platform technology and on-demand platform business content. In some instances, the images may be replicated to other locations (e.g., another backend server) after they are generated from one backend server. In some instances, the backend servers 102, 120 may include a web server or be communicably coupled with a web server, where one or more of the network applications 108 associated with the backend servers 102, 120 represent web-based (or web-accessible) applications accessed and executed through requests and interactions received on the front-end client 150a, 150b operable to interact with the programmed tasks or operations of the corresponding on-demand platform and/or network applications.

At a high level, the backend servers 102, 120 include an electronic computing device operable to receive, transmit, process, store, or manage data and information associated with the environment 100. The backend servers 102, 120 illustrated in FIG. 1 can be responsible for receiving requests from one or more clients 150a, 150b (as well as any other entity or system interacting with the backend servers 102, 120, including desktop or mobile client systems), responding to the received requests by processing said requests in an on-demand platform and/or an associated network application, and sending the appropriate responses from the appropriate component back to the requesting front-end client 150a, 150b or other requesting system. Components of the backend servers 102, 120 can also process and respond to local requests from a user locally accessing the backend servers 102, 120. Accordingly, in addition to requests from the front-end client 150a, 150b illustrated in FIG. 1, requests associated with a particular component may also be sent from internal users, external or third-party customers, and other associated network applications, business processes, as well as any other appropriate entities, individuals, systems, or computers. In some instances, either or both an on-demand platform and/or a network application may be web-based applications executing functionality associated with a networked or cloud-based business process.

As used in the present disclosure, the term “computer” is intended to encompass any suitable processing device. For example, although FIG. 1 illustrates three backend servers 102, 120, environment 100 can be implemented using any number of servers, as well as computers other than servers, including a server pool. Indeed, the backend servers 102, 120 and/or the clients 150a, 150b may be any computer or processing device such as, for example, a blade server, general-purpose personal computer (PC), Macintosh®, workstation, UNIX®-based workstation, or any other suitable device. In other words, the present disclosure contemplates computers other than general purpose computers, as well as computers without conventional operating systems. Further, the illustrated backend servers 102, 120 may be adapted to execute any operating system, including Linux®, UNIX®, Windows®, Mac OS®, or any other suitable operating system.

The first backend server 102 is illustrated in detail in FIG. 1. The first backend server 102 includes an interface 104, a processor 106, a memory or tile cache 110, a Rendering Process Engine 108, and other components further illustrated in FIG. 8. In some instances, the backend servers 102, 120 and its illustrated components may be separated into multiple components executing at different servers and/or systems. For example, while FIG. 1 illustrates the Rendering Process Engine 108 and the processor 106 as separate components, other example implementations can include the processor 106 within a separate system, as well as within as part of the network application's inherent functionality. Thus, while illustrated as a single component in the example environment 100 of FIG. 1, alternative implementations may illustrate the backend servers 102, 120 as comprising multiple parts or portions accordingly.

In FIG. 1, the interface 104 is used by the first backend server 102 to communicate with other systems in a client-server or other distributed environment (including within environment 100) connected to the network 140 (e.g., one of the front-end clients 150a, 150b, as well as other clients or backend servers communicably coupled to the network 140). The term “interface” 104, 152 generally includes logic encoded software and/or hardware in a suitable combination and operable to communicate with the network 140. More specifically, the interface 104 may comprise software supporting one or more communication protocols associated with communications such that the network 140 or the interface's hardware is operable to communicate physical signals within and outside of the illustrated environment 100. Generally, the backend servers 102, 120 may be communicably coupled with a network 140 that facilitates wireless or wireline communications between the components of the environment 100 (e.g., among the backend servers 102, 120 and/or one or more front-end clients 150a, 150b), as well as with any other local or remote computer, such as additional clients, servers, or other devices communicably coupled to network 140, including those not illustrated in FIG. 1. In the illustrated environment, the network 140 is depicted as a single network, but may be comprised of more than one network without departing from the scope of this disclosure, so long as at least a portion of the network 140 may facilitate communications between senders and recipients. In some instances, one or more of the components associated with the backend servers 102, 120 may be included within the network 140 as one or more cloud-based services or operations.

The term “network” refers to all or a portion of an enterprise or secured network, while in another instance, at least a portion of the network 140 may represent a connection to the Internet. In some instances, a portion of the network 140 may be a virtual private network (VPN). Further, all or a portion of the network 140 can include either a wireline or wireless link. Example wireless links may include 802.11a/b/g/n, 802.20, WiMax®, and/or any other appropriate wireless link. In other words, the network 140 encompasses any internal or external network, networks, sub-network, or combination thereof operable to facilitate communications between various computing components inside and outside the illustrated environment 100. The network 140 may communicate, for example, Internet Protocol (IP) packets, Java Debug Wire Protocol (JDWP), Frame Relay frames, Asynchronous Transfer Mode (ATM) cells, voice, video, data, and other suitable information between network addresses. The network 140 may also include one or more local area networks (LANs), radio access networks (RANs), metropolitan area networks (MANs), wide area networks (WANs), all or a portion of the Internet, and/or any other communication system or systems at one or more locations.

As illustrated in FIG. 1, the first backend server 102 includes a processor 106. Although illustrated as a single processor 106 in the backend server 102, two or more processors may be used in the backend server 102 according to particular needs, desires, or particular embodiments of environment 100. The backend servers 120 and 102, as well as other backend systems, may similarly include one or more processors. The term “processor” refers to a central processing unit (CPU), a blade, an application specific integrated circuit (ASIC), a field-programmable gate array (FPGA), or another suitable component, e.g. graphics processing unit. Generally, the processor 106 executes instructions and manipulates data to perform the operations of the backend server 102, and, specifically, the functionality associated with the corresponding Rendering Process Engine 108. In one implementation, the server's processor 106 executes the functionality required to receive and respond to requests and instructions from the front-end client 150a, 150b, as well as the functionality required to perform the operations of the associated Rendering Process Engine 108 and an on-demand platform, among others.

At a high level, the term “software application” and “networked application” described in this specification refer to any application, program, module, process, or other software that may execute, change, delete, generate, or otherwise manage information associated with the server 102, 120 or the client device 150a, 150b, and in some cases, a business process performing and executing business process-related events. In particular, business processes communicate with other users, applications, systems, and components to send, receive, and process events. In some instances, a particular Rendering Process Engine 108 may operate in response to and in connection with one or more requests received from an associated client or other remote client. Additionally, a particular Rendering Process Engine 108 may operate in response to and in connection with one or more requests received from other network applications external to the backend server 102. In some instances, the Rendering Process Engine 108 can be a networked application, for example, the Rendering Process Engine 108 is built on a common platform with one or more applications in either or both of the backend servers 120 and 102. In some instances, the Rendering Process Engine 108 may request additional processing or information from an external system or application. In some instances, each Rendering Process Engine 108 may represent a web-based application accessed and executed by the front-end client 150a, 150b via the network 140 (e.g., through the Internet, or via one or more cloud-based services associated with the Rendering Process Engine 108).

Further, while illustrated as internal to the backend server 102, one or more processes associated with a particular Rendering Process Engine 108 may be stored, referenced, or executed remotely. For example, a portion of a particular Rendering Process Engine 108 may be a web service that is remotely called, while another portion of the Rendering Process Engine 108 may be an interface object or agent bundled for processing at a remote system. Moreover, any or all of a particular Rendering Process Engine 108 may be a child or sub-module of another software module or enterprise application (e.g., the backend servers 120 and 130). Still further, portions of the particular Rendering Process Engine 108 may be executed or accessed by a user working directly at the backend servers 102, as well as remotely at corresponding front-end client 150a, 150b.

Regardless of the particular implementation, “software” may include computer-readable instructions (e.g., programming code), firmware, wired or programmed hardware, or any combination thereof on a tangible and non-transitory medium operable when executed to perform at least the processes and operations described herein. Indeed, each software component may be fully or partially written or described in any appropriate computer language including C, C++, Java®, Visual Basic®, assembler, Perl®, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate. In the illustrated environment 100, the processor 106 executes the corresponding Rendering Process Engine 108 stored on the associated backend servers 120. In some instances, a particular backend server may be associated with the execution of two or more network applications (and other related components), as well as one or more distributed applications executing across two or more servers executing the functionality associated with the backend servers.

In some implementations, the server 102, 120 can communicate with client device 150a, 150b using the hypertext transfer protocol (HTTP) or hypertext transfer protocol secure (HTTPS) requests. In some implementations, the server 102, 120 can use a remote function call (RFC) interface to communication with advanced business application programming (ABAP) language and/or non-ABAP programs, e.g. ODBC requests.

FIG. 1 further includes memory 109 with tile cache 110 in the backend server 102. For example, the backend server 102 can host a master application for a particular data object, which is stored at the memory 110. The data object stored at the memory 110 may be accessed by other networked applications, for example, by applications of the backend servers 120 and 102. The data access does not require data replication and therefore can be stored at a single location (e.g., the memory 110). In addition, the memory 110 of the backend server 120 stores data and program instructions for the Rendering Process Engine 108. The term “memory” refers to any memory or database module and may take the form of volatile or non-volatile memory including, without limitation, magnetic media, optical media, random access memory (RAM), read-only memory (ROM), removable media, or any other suitable local or remote memory component.

The memory 109 or tile cache 110 may store various image tiles, business objects, object models, and data, including classes, frameworks, applications, backup data, business objects, jobs, web pages, web page templates, database tables, process contexts, repositories storing services local to the backend server 120 and any other appropriate information including any parameters, variables, algorithms, instructions, rules, constraints, or references thereto associated with the purposes of the backend server 120 and its functionality. In an aspect, the term “business object” is a representation of an intelligible business or non-business entity, such as an account, an order, employee, an invoice or a financial report. In some implementations, including in a cloud-based system, some or all of the memory 110 may be stored remote from the backend server 120 and communicably coupled to the backend server 120 for usage. As described above, memory 110 can include one or more meta-models associated with various objects included in or associated with the underlying platform. Specifically, memory 109 or tile cache 110 can store items, tiles, and entities related to the Rendering Process Engine 108 and/or other collaboration-related entities or components. Some or all of the elements illustrated within memory 109 or tile cache 110 may be stored external to the memory 109 or tile cache 110.

In an aspect of the implementations described herein, a system 100 for providing access to vector data on a mobile device 150a, 150b may comprise: a mobile device 150a, 150b; a server 102, 120 remote from the mobile device 150a, 150b; the mobile device 150a, 150b configured to: transmit, from the mobile device to the remote server, one or more requests for first vector data, the requests specifying the first vector data, a display property of the mobile device, a first zoom level and a location within the vector data; and the remote server 102, 120 configured: determine, based on the one or more requests, one or more image tiles representing information of the requested first vector data; and provide the one or more image tiles to the mobile device for display.

FIG. 2 illustrates examples 200 for rendering vector data, such as CAD data, augmented reality data, complex charts or flow diagrams, hierarchy diagrams, schematic drawings and/or text data. Vector data allows the use of computer systems to assist in the creation, modification, analysis, or optimization of a design of a physical object. Associated software may be used to increase the productivity of the designer, improve the quality of design, improve communications through documentation, and to create a database for manufacturing. Vector data is often in the form of electronic files for print, machining, or other manufacturing operations. CAD software for mechanical design uses either vector-based graphics to depict the objects of traditional drafting, or may also produce raster graphics showing the overall appearance of designed objects. As in the manual drafting of technical and engineering drawings, the output of CAD must convey information, such as materials, processes, dimensions, and tolerances, according to application-specific conventions. CAD may be used to design figures in two-dimensional (2D) space, or curves, surfaces, and solids in three-dimensional (3D) space. The CAD Data may be enriched by some metadata, which indicates characteristics of objects in the vector data. For example the metadata may indicate the positions of fire extinguishers in a building covered by the vector data.

In many applications it can be helpful to display CAD data. There are different ways to do this. In one example, CAD data can be transported to the client 150a, 150b and rendered there. Another possibility is to render the data on the server 102, 120 and transport an image representing the rendered data to the client 150a, 150b. There are at least two possibilities to do this. In one instance, a single image is rendered using the CAD data and completely transported to the client 150a, 150b. A second possibility is tile-based rendering. This application describes this possibility, which is shown as the ‘CAD Data’→‘Render on Server’→“Tile based Rendering” branch in FIG. 2.

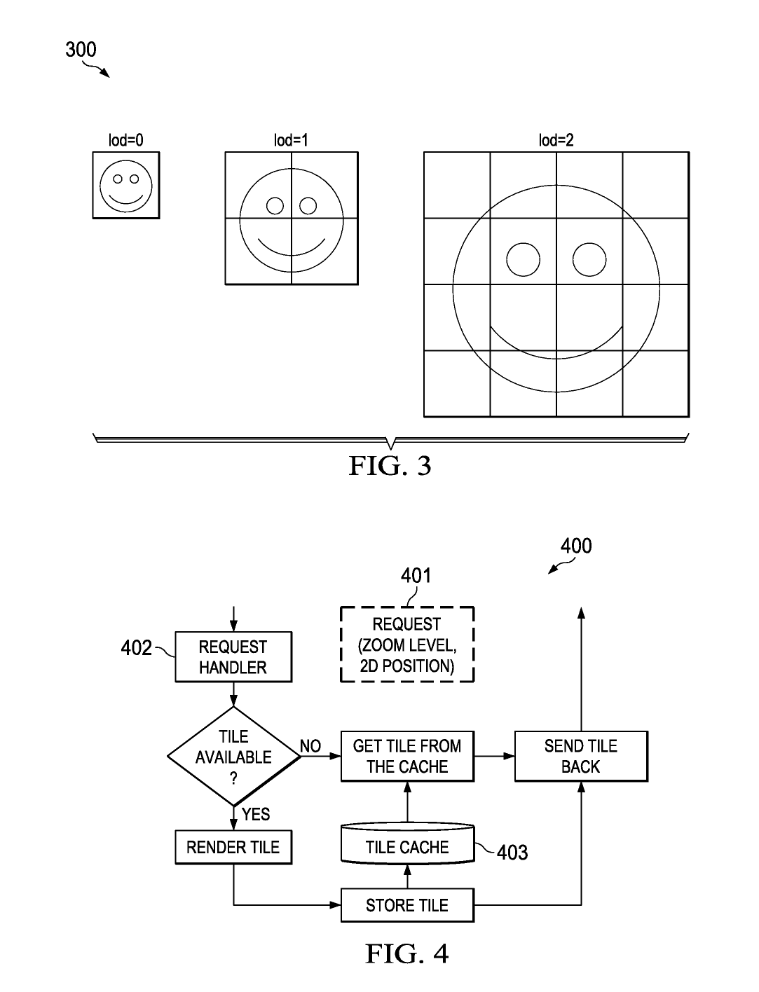

FIG. 3 illustrates tile-based rendering. The term “image tile,” as used herein, may be understood as an image file in an image file format, such as Joint Photographic Experts Group (jpeg), Graphics Interchange Format (gif), Tagged Image File Format (tif), or Portable Network Graphics (png). For example, the image tile may contain image data of a portion of a digital image. The size of an image tile may be less than 2 MB, for example may be just a few kB (e.g. 50 kB) large.

The tile-based rendering may be based the level of detail (lod) or zoom level. In an exemplary embodiment, whenever the level of detail or zoom level is incremented by one, the number of tiles gets quadrupled. As illustrated in the example of FIG. 3, at lod=0, a single tile may be rendered, at lod=1, a 2×2 tile matrix (4 tiles), at lod=2, a 4×4 tile matrix (16 tiles) may be rendered. Other scenarios of the number of image tiles as a function of zoom level can be envisioned and are covered by the present application.

FIG. 4 illustrates an example process 400, performed by the remote server 102, for providing access to vector data (e.g., CAD data) on a mobile device 150a, 150b. In an aspect, the process comprises: receiving, by a request handler 402 and from the mobile device, one or more requests 401 for first vector data, the requests specifying the first vector data, a display property of the mobile device, a first zoom level and a location within the vector data; determining, by the rendering process engine 108 (see FIG. 1) at the remote server and based on the one or more requests, one or more image tiles representing information of the requested first vector data; providing, by the remote server, the one or more image tiles to the mobile device for display. In an aspect, the request may be received from a first mobile device 150a and the image tiles may be provided to a second mobile device 150b different from the first mobile device. In an aspect, the determining, by the remote server, of the one or more image tiles includes: determining, by the rendering process engine 108, that image tiles associated with the requested vector data exists in the tile cache 403, and then identifying the one or more image tiles in a tile cache 403 and retrieving, by the server, the one or more image tiles from the tile cache 403. For example, the location includes two-dimensional tile coordinates, and wherein the identifying of the one or more image tiles in the cache includes identifying a quad key associated with the one or more image tiles. One possibility to store 2-dimensional vector data is by quad-key interface.

See here for details: http://msdn.microsoft.com/en-us/library/bb259689.aspx. To optimize the indexing and storage of tiles, the two-dimensional tile XY coordinates are combined into one-dimensional strings called quad tree keys, or “quad keys” for short. Each quad key uniquely identifies a single tile at a particular level of detail, and it can be used as an key in common database B-tree indexes. To convert tile coordinates into a quad key, the bits of the Y and X coordinates are interleaved, and the result is interpreted as a base-4 number (with leading zeros maintained) and converted into a string. The data is stored in a 3D matrix with the X,Y, and zoom level dimensions.

Three-dimensional (3D) data can be stored in an enhanced Quad Key plus view-angle interface. Quad Key plus view-angle interface in 3D may be realized as followed:

3D navigation ground based graphics:

1. Definition of 3D navigation ground based graphics:
The observer or “the camera” can may move with a constant attitude above the ground and moves only 2 dimensional. (Analogous to a geographical 3D world where the camera or observer moves on the ground)

2. Spatial Limitations:
a. The camera may be limited to a discrete raster of camera locations—camera locations between 2 points may be inhibited.
b. The camera rotation may also be limited to a discrete number of angles (e.g. in steps of 1, 5, 10, 20 or 45 degrees). E.g. if a delta of 90° is defined only camera looking directions in North, East, South and West direction will be possible.
c. The inclination of the camera, e.g. between +/−90°, +/−45°, +/−10°, from the horizontal direction may also be discrete.
d. Only a discrete number of camera view angles between, for instance in steps of 1, 5, 10, 20 or 45 degrees between 0-180° may be allowed. This may be analogous to the zoom levels and has the same effect.

The number of rendered images may be then:

Number of locations*Number of camera angles*Number of inclination angles*Number of rotation angles

This can be arranged in a 5 dimensional matrix analogous to the quad key interface. (Coordinates: x,y, camera zoom (camera angle), inclination, rotation). Quad keys may provide a one-dimensional index key that usually preserves the proximity of tiles in XY space. In other words, two tiles that have nearby XY coordinates usually have quad keys that are relatively close together. This may be useful for optimizing database performance, because neighboring tiles are usually requested in groups, and it's desirable to keep those tiles on the same disk blocks, in order to minimize the number of disk reads.

The rendering process engine 108 (see FIG. 1) may determine that image tiles associated with the requested first vector data are not yet available, so that the determining, by the remote server, of the one or more image tiles further includes: rendering, by the rendering process engine 108 at the remote server, the requested vector data; generating, by the remote server, the one or more image tiles from the rendered vector data according to the display property, the zoom level and the location; storing, by the remote server, the generated one or more image tiles in a tile cache 403; and sending the image tiles to the mobile device.

In an aspect, the location in request 401 includes two-dimensional tile coordinates, and the generating, by the remote server, of the one or more image tiles from the rendered vector data may include: combining the coordinates into a one-dimensional string, which identifies the image tiles at the zoom level. In an aspect, the process 400 may further comprise: before the receiving of the one or more requests, performing, by the mobile device, a pre-processing, the pre-processing comprising: constructing one or more additional requests for additional vector data associated with the requested vector data, the additional requests specifying the additional vector data; and determining, by the remote server and based on the one or more additional requests, one or more additional image tiles representing information of the requested additional vector data; providing, by the remote server, the one or more additional image tiles to the mobile device for display. For example, the additional requests specify one or more other zoom levels, and wherein the additional vector data is data associated with the other (e.g. one zoom level higher or lower than the initial zoom level in the request 401) zoom levels, or wherein the additional requests specify one or more other (e.g. neighboring) locations, and wherein the additional vector data is data associated with the other locations.

In an aspect, the process 400 may further comprise: receiving, by the server and from the mobile device, a query for data associated with an object (e.g. the location of an object within the vector data) within the image tiles; retrieving the data associated with the object from metadata associated with the first vector data; providing, by the remote server, the retrieved data associated with the object to the mobile device for display. For example, the user may be interested in locations of fire extinguishers within a building, which is at least partially displayed in the image tiles on the mobile device. In response to the query, the mobile device may receive, from the server, search results including the locations of the objects of interest. For example, the server may update the image tiles displayed on the mobile device, wherein the updated image tiles include highlighted information derived from the search results. For example the updated image tiles may include highlighted locations of the object within the building (e.g. all locations where fire extinguishers are located within the relevant building).

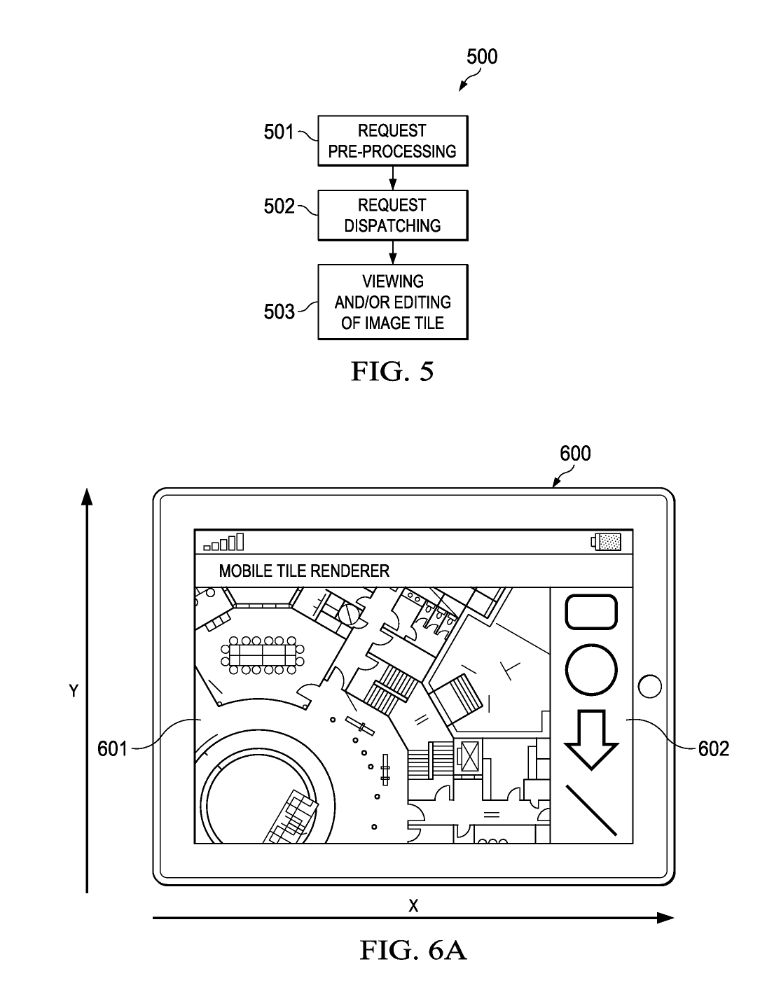

FIG. 5 illustrates an exemplary process 500 for receiving access to vector data on the mobile device 150a, 150b. The process 500 may comprise a request pre-processing 501 that is performed before a transmitting, from the mobile device to a remote server, of one or more requests for first vector data, the requests specifying the first vector data, a display property of the mobile device, a first zoom level and a location within the vector data. The process 500 may include receiving, by the mobile device, one or more image tiles representing information of the requested first vector data and viewing and/or editing (e.g. create, modify, update or delete) 503 the displayed image tiles. The process 500 may further include a request dispatching 502, which may include determining, by the remote server and based on the one or more requests, one or more image tiles representing information of the requested first vector data.

The process operation 501 may further comprise: performing, by the mobile device, a pre-processing, the pre-processing comprising: determining a required number of the image tiles associated with the requested vector data based on the zoom level and a size of the display of the mobile device; and transmitting, before the receiving of the one or more image tiles, the determined number of the image tiles to the remote server, wherein the number of the received one or more image tiles is substantially equal to the required number of the image tiles. The process operation 501 may further comprise: performing, by the mobile device, a pre-processing, the pre-processing comprising: constructing one or more additional requests for additional vector data associated with the requested vector data, the additional requests specifying the additional vector data; and transmitting, by the mobile device, the one or more additional requests to the remote server; and receiving, by the mobile device and from the remote server, one or more image tiles representing information of the requested additional vector data. In an aspect, the additional requests specify one or more other (e.g. higher or lower) zoom levels, and wherein the additional vector data is data associated with the other zoom levels, or wherein the additional requests specify one or more other (e.g., neighboring) locations, and wherein the additional vector data is data associated with the other locations.

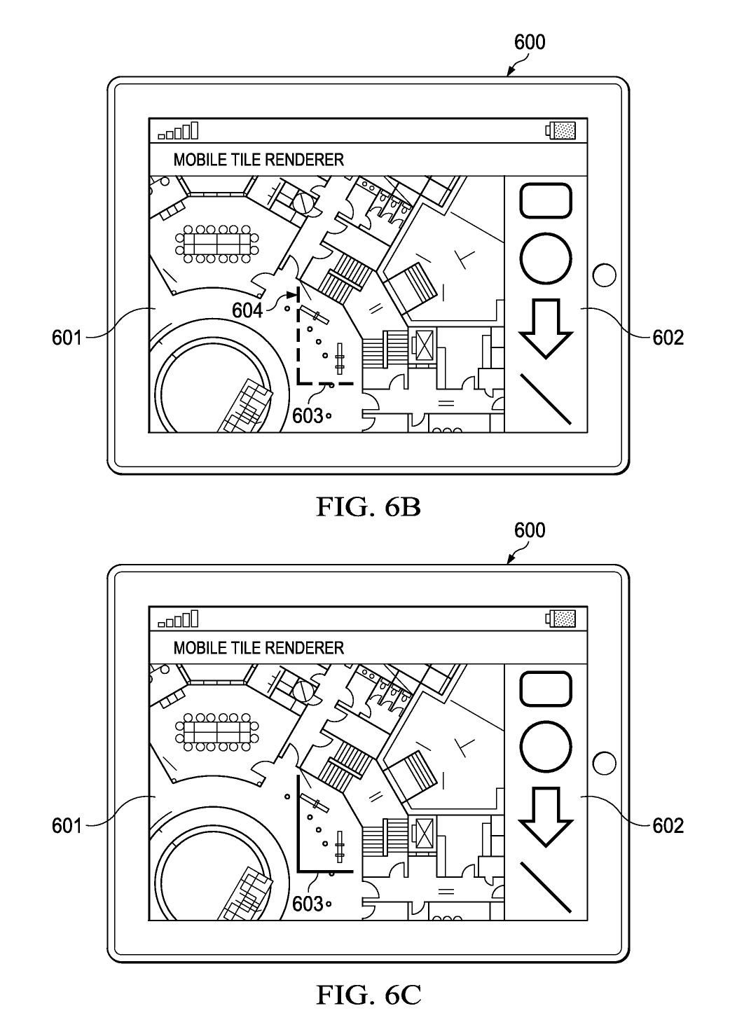

The process operation 503 may further comprise: transmitting, from the mobile device to a remote server, a command to modify the first vector data (e.g. to add, remove, update or modify an object in the vector data, as illustrated in FIGS. 6B-C) and receiving, by the mobile device, one or more updated image tiles representing information of modified first vector data that was modified by the server according to the command. For example, the user may request (e.g. by activating an icon associated with the displayed image tile) that fire extinguishers may be added to a particular floor within the building associated with the displayed image tiles. The server may then change the vector data associated with the image tiles and may generate updated image tiles that represent the changed vector data.

The process operation 503 may further comprise: displaying, by the mobile device, the one or more image tiles; receiving a user navigation with respect to the displayed image tiles; and pre-fetching (e.g., storing image tiles requested and received from the server in a memory on the mobile device) additional information along a dimension of the user navigation, wherein more information is pre-fetched for the dimension in which the user navigation is the fastest. For example, the dimension includes at least one of zoom level, X coordinate of the display area, or Y coordinate of the display area (see example in FIG. 6A). For example, if the user mainly (e.g. predominantly) navigates by zooming in or out (e.g., changing the zoom level), but does substantially not navigate across the area of the displayed image tiles, then more information is pre-fetched for the zoom level the user navigates to. Similarly, if the user navigates horizontally across the displayed image tiles, but does navigate less fast in a vertical dimension, then more information is pre-fetched in the horizontal dimension. In an aspect, the pre-fetched image tiles are predominantly in a direction given by the velocity vector of the user navigation. In an aspect, the pre-fetching of the additional information comprises: downloading, by the mobile device and during the receiving of the user navigation, image tiles outside a periphery of the currently displayed image tiles for subsequent display. The process operation 503 may further comprise: displaying, by the mobile device, the one or more image tiles; and requesting, by the mobile device and from the server, neighboring image tiles that are neighboring to the currently displayed image tiles, wherein the neighboring image tiles are pre-fetched.

The process operation 503 may further comprise: receiving, at the mobile device, one or more requests for second vector data different from the first vector data, the second requests specifying the second vector data; determining, by the mobile device, that the requests for the first vector data are likely of lower priority than the requests for the second vector data; initiating, by the mobile device, the remote server to prioritize the requests for the second vector data over the requests for the first vector data; transmitting, by the mobile device, the requests for the second vector data to the remote server; and receiving, by the mobile device and from the remote server, one or more image tiles representing information of the requested second vector data. For example, the mobile device may determine that the first request for first vector data is not needed or invalid any may cause stopping of the processing (e.g., by the server) of this request or may make the second request top priority for the server-side processing illustrated in FIG. 4.

FIGS. 6A-C illustrate an example graphical user interface (GUI) 600 on the mobile device 150a, 150b. The GUI may display the image tiles 601 received from the server and upon the request for the associated first vector data mentioned above (e.g., CAD data as shown in FIG. 6A). The GUI may also include one or more icons or interactional objects 602, that is configured to be activated by the user (e.g. by using a pointer 604), and that is configured to cause the mobile device to transmit a request (e.g. the above mentioned request for first vector data, or the second request or the additional requests) or a command (e.g. the above mentioned command for a change of vector data) to the remote server. For example, the dimensions of the image tiles may include at least one of zoom level, X coordinate of the display area, or Y coordinate of the display area.

As illustrated in FIG. 6B, the user may activate one or more of the icons 602 with pointer 604, which may allow the user to edit the displayed image tile, e.g. by drawing an object 603, and may cause the mobile device to transmit, to the remote server 102, a command to modify the first vector data (e.g. to add, remove, update or modify an object 603 in the vector data). This command may be initiated by a further activation of one or more of the icons 602 or may be initiated by finishing the drawing of the object 603 (e.g., by releasing the pressure on the mouse pointer 604).

As illustrated in FIG. 6C, upon the initiation of the command, the mobile device may receive one or more updated image tiles 605 from the remote server 102 representing information of modified vector data that was modified by the server 102 according to the command. For example, the user may request (e.g. by activating an icon or button 602) that an object 603, such as a wall, should be added to or removed from a displayed area, such as a building or room, or that fire extinguishers may be added to a particular floor within the building associated with the displayed image tiles 601. The server may then change the vector data associated with the image tiles and may generate updated image tiles 605 that represent the changed vector data.

In an aspect, the GUI 600 may further provide the user of the mobile device 150a, 150b with the possibility to submit queries for metadata associated with the vector data with which the displayed image tiles are associated. For example, one or more of the icons 602 may include a query field configured to receive a user query for data associated with an object (e.g. the location of an object within the vector data) within the image tiles, and to cause the remote server 102 to retrieve the data associated with the object from metadata associated with the vector data. The server may subsequently provide the retrieved data associated with the object to the mobile device for display. For example, the user may be interested in locations of electrical wires or plugs in the area of the wall 603. In response to the query, the mobile device may receive, from the server, search results including the locations of the objects of interest. For example, the server may update the image tiles 605 displayed on the mobile device, wherein the updated image tiles include highlighted information derived from the search results. For example the updated image tiles may include highlighted locations of the object within the building (e.g. all locations where electrical wires or plugs are to be placed). 601 and 605 may be one or more image tiles, which may be invisible to the user of the mobile device 150a, 150b.

According to one or more embodiments described herein, the user may perform a mobile and rapid prototyping of a design of physical objects, e.g., at a construction side. The user may change vector data (e.g. CAD data) through changing image tiles (e.g. in jpeg, gif, tif or png format).

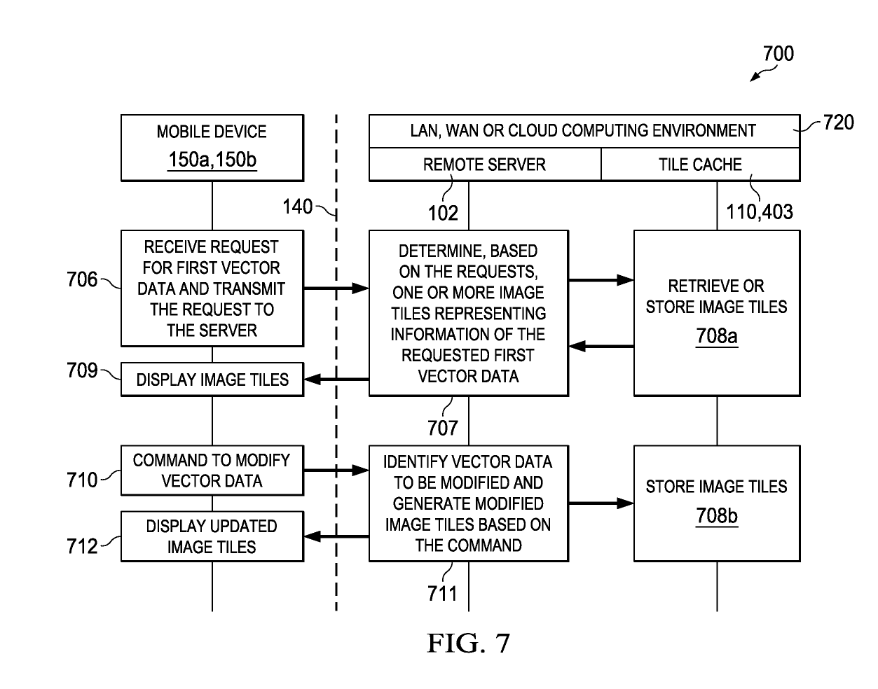

FIG. 7 illustrates an exemplary method or process 700 for providing access to vector data on a mobile device 150a, 150b. Mobile device 150a, 150b may be connected with remote server 102 via network 140 (e.g, LAN or WAN) and the remote server 102 may be connected to one or more databases 120, 403 via a network (e.g., LAN or WAN) connection. The remote server 102 and/or the database 120, 403 may be implemented in a cloud computing environment 720.

At 706, the mobile device 150a, 150b receives or identifies one or more requests for first vector data and transmit the requests to the server 102 via the network connection. The requests may specify the first vector data, a display property (e.g. size and/or screen resolution) of the mobile device, and a first zoom level and a location (e.g., (X; Y) coordinates) within the vector data.

At 707, the remote server 102 determines, based on the one or more requests, one or more image tiles representing information of the requested first vector data. The determining, by the remote server (e.g., by rendering process engine 108 in FIG. 1), of the one or more image tiles may include: identifying 708a, by the remote server, the one or more image tiles in a tile cache 110, 403 and retrieving 708a, by the server (e.g., by rendering process engine 108 in FIG. 1), the one or more image tiles from the tile cache, or wherein the determining, by the remote server, of the one or more image tiles may include: rendering, by rendering process engine 108 at the remote server, the requested vector data; generating, by the remote server (e.g., by rendering process engine 108 in FIG. 1), the one or more image tiles from the rendered vector data according to the display property, the zoom level and the location; and storing 708a, by the remote server (e.g., by rendering process engine 108 in FIG. 1), the generated one or more image tiles in the tile cache 110, 403 for subsequent retrieval.

At 709, the remote server 102 provides the one or more generated or retrieved image tiles to the mobile device 150a, 150b, which displays the received image tiles.

At 710, the mobile device transmits a command to the server, wherein the command requests a modification of the first vector data. Referring to FIG. 6B, the user may activate one or more of the icons 602 with pointer 604, which may allow the user to edit the displayed image tile, e.g. by drawing an object 603, and may cause the mobile device to transmit, to the remote server 102, the command to modify the first vector data (e.g. to add, remove, update or modify an object 603 in the vector data).

At 711, the server identifies relevant vector data of the first vector data to be modified and modifies the relevant vector data according to the received command. Then, the server (e.g., the rendering process engine 108 in FIG. 1) generates updated image tiles (e.g., image tiles 605 in FIG. 6C) based on the modified first vector data and stores the updated image tiles in the tile cache 110, 403.

At 712, the remote server 102 provides the one or more modified image tiles (e.g., image tiles 605 in FIG. 6C) to the mobile device 150a, 150b, which displays the updated image tiles, e.g. by replacing the image tiles displayed in operation 709 by the updated image tiles received in operation 712.

The preceding figures and accompanying description illustrate example processes and computer implementable techniques. But network environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, each network environment may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art.

What is claimed is:

1. A computer-implemented method for providing access to vector data on a mobile device, the method comprising:
receiving, at a remote server and from the mobile device, one or more requests for first vector data, the requests specifying the first vector data, a display property of the mobile device, a first zoom level and a location within the vector data;
determining, by the remote server and based on the one or more requests, one or more image tiles representing information of the requested first vector data; and
providing, by the remote server, the one or more image tiles to the mobile device for display.

2. The method of claim 1, wherein the vector data is Computer-Aided Design (CAD) data or text data.

3. The method of claim 1, wherein the determining, by the remote server, of the one or more image tiles includes:
identifying, by the remote server, the one or more image tiles in a tile cache and retrieving, by the server, the one or more image tiles from the tile cache.

4. The method of claim 1, wherein the determining, by the remote server, of the one or more image tiles includes:
rendering, by the remote server, the requested vector data;
generating, by the remote server, the one or more image tiles from the rendered vector data according to the display property, the zoom level and the location; and
storing, by the remote server, the generated one or more image tiles in a cache.

5. The method of claim 1, wherein the location includes two-dimensional tile coordinates, and wherein the generating, by the remote server, of the one or more image tiles from the rendered vector data includes:
combining the coordinates into a one-dimensional string, which identifies the image tiles at the zoom level.

6. The method of claim 1, further comprising:
before the receiving of the one or more requests, performing, by the mobile device, a pre-processing, the pre-processing comprising:
constructing one or more additional requests for additional vector data associated with the requested vector data, the additional requests specifying the additional vector data;
determining, by the remote server and based on the one or more additional requests, one or more additional image tiles representing information of the requested additional vector data;
and
providing, by the remote server, the one or more additional image tiles to the mobile device for display.

7. The method of claim 6, wherein the additional requests specify one or more other zoom levels, and wherein the additional vector data is data associated with the other zoom levels, or wherein the additional requests specify one or more other locations, and wherein the additional vector data is data associated with the other locations.

8. The method of claim 1, further comprising:
receiving, by the server and from the mobile device, a query for data associated with an object within the image tiles;
retrieving the data associated with the object from metadata associated with the first vector data; and
providing, by the remote server, the retrieved data associated with the object to the mobile device for display.

9. A computer-implemented method for receiving access to vector data on a mobile device, the method comprising:
transmitting, from the mobile device to a remote server, one or more requests for first vector data, the requests specifying the first vector data, a display property of the mobile device, a first zoom level and a location within the vector data; and
receiving, by the mobile device, one or more image tiles representing information of the requested first vector data.

10. The method of claim 9, further comprising:
before the transmitting of the one or more requests, performing, by the mobile device, a pre-processing, the pre-processing comprising:
determining a required number of the image tiles associated with the requested vector data based on the zoom level and a size of the display of the mobile device; and
transmitting, before the receiving of the one or more image tiles, the determined number of the image tiles to the remote server, wherein the number of the received one or more image tiles is substantially equal to the required number of the image tiles.

11. The method of claim 9, further comprising:
before the transmitting of the one or more requests, performing, by the mobile device, a pre-processing, the pre-processing comprising:
constructing one or more additional requests for additional vector data associated with the requested vector data, the additional requests specifying the additional vector data; and
transmitting, by the mobile device, the one or more additional requests to the remote server;
and
receiving, by the mobile device and from the remote server, one or more image tiles representing information of the requested additional vector data.

12. The method of claim 11, wherein the additional requests specify one or more other zoom levels, and wherein the additional vector data is data associated with the other zoom levels, or wherein the additional requests specify one or more other locations, and wherein the additional vector data is data associated with the other locations.

13. The method of claim 9, further comprising:
transmitting, from the mobile device to a remote server, a command to modify the first vector data, preferably wherein the command specifies to add, change or remove an object; and
receiving, by the mobile device, one or more updated image tiles representing information of modified first vector data that was modified by the server according to the command.

14. The method of claim 9, further comprising:
displaying, by the mobile device, the one or more image tiles;
receiving a user navigation with respect to the displayed image tiles; and
pre-fetching additional information along a dimension of the user navigation, wherein more information is pre-fetched for the dimension in which the user navigation is the fastest.

15. The method of claim 14, wherein the dimension includes at least one of zoom level, X coordinate of the display area, or Y coordinate of the display area.

16. The method of claim 14, wherein the pre-fetching of the additional information comprises:
downloading, by the mobile device and during the receiving of the user navigation, image tiles outside a periphery of the currently displayed image tiles for subsequent display.

17. The method of claim 9, further comprising:
displaying, by the mobile device, the one or more image tiles; and
requesting, by the mobile device and from the server, neighboring image tiles that are neighboring to the currently displayed image tiles, wherein the neighboring image tiles are pre-fetched.

18. The method of claim 9, further comprising:
receiving, at the mobile device, one or more requests for second vector data different from the first vector data, the second requests specifying the second vector data;
determining, by the mobile device, that the requests for the first vector data are likely of lower priority than the requests for the second vector data;
initiating, by the mobile device, the remote server to prioritize the requests for the second vector data over the requests for the first vector data;
transmitting, by the mobile device, the requests for the second vector data to the remote server; and
receiving, by the mobile device and from the remote server, one or more image tiles representing information of the requested second vector data before the one or more image tiles representing information of the requested first vector data.

19. A computer-readable storage medium, the storage medium comprising computer-readable instructions for causing one or more computers to perform operations for providing access to vector data on a mobile device, the operations comprising:
receiving, at a remote server and from the mobile device, one or more requests for first vector data, the requests specifying the first vector data, a display property of the mobile device, a first zoom level and a location within the vector data;
determining, by the remote server and based on the one or more requests, one or more image tiles representing information of the requested first vector data; and
providing, by the remote server, the one or more image tiles to the mobile device for display.

20. The medium of claim 19, wherein the vector data is Computer-Aided Design (CAD) data or text data.

21. A system for providing access to vector data on a mobile device, the system comprising:
a mobile device;
a server remote from the mobile device;
the mobile device configured to:
transmit, from the mobile device to the remote server, one or more requests for first vector data, the requests specifying the first vector data, a display property of the mobile device, a first zoom level and a location within the vector data; and
before the transmitting of the one or more requests, perform, a pre-processing, the pre-processing comprising:
constructing one or more additional requests for additional vector data associated with the requested vector data, the additional requests specifying the additional vector data; and
transmitting, by the mobile device, the one or more additional requests to the remote server;
and
the remote server configured to:
determine, based on the one or more requests, one or more image tiles representing information of the requested first vector data and one or more image tiles representing information of the additional vector data; and
provide the determined image tiles to the mobile device.

22. The system of claim 21, wherein the additional requests specify one or more other zoom levels, and wherein the additional vector data is data associated with the other zoom levels, or wherein the additional requests specify one or more other locations, and wherein the additional vector data is data associated with the other locations.
